(19) United States
(12) Patent Application Publication
(10) Pub. No.: US 2019/0304668 A1
(43) Pub. Date: Oct. 3, 2019

(54) HIGH-VOLTAGE COIL, TRANSFORMER AND METHOD FOR MANUFACTURING HIGH-VOLTAGE COIL

(71) Applicant: Delta Electronics,Inc., Taoyuan City (CN)

(72) Inventors: Shizhong GUO, Taoyuan City (CN); Quanliang ZHANG, Taoyuan City (CN)

(73) Assignee: Delta Electronics,Inc., Taoyuan City (CN)

(21) Appl. No.: 16/361,991

(22) Filed: Mar. 22, 2019

(30) Foreign Application Priority Data
Mar. 28, 2018 (CN) 201810262383.8

(51) Int. Cl. H01F 27/32; H01F 27/28; H01F 27/24; H01F 27/02; H01F 41/098; H01F 41/12

(52) U.S. Cl. CPC H01F 27/327; H01F 27/2823; H01F 27/325; H01F 41/127; H01F 27/022; H01F 41/098; H01F 27/24

(57) ABSTRACT

A method for manufacturing a high-voltage coil includes: forming a winding frame by casting a first casting material; forming a winding by coiling a wire around the winding frame; assembling the winding in a shell; and casting a second casting material between the winding frame and the shell, enabling the second casting material to be fully filled between the winding frame and the shell. The high-voltage coil with good insulation characteristic can be manufactured through the method for manufacturing a high-voltage coil provided by the present disclosure.

### CROSS REFERENCE

This application is based upon and claims priority to Chinese Patent Application No. 201810262383.8, filed on Mar. 28, 2018, the entire contents thereof are incorporated herein by reference.

### TECHNICAL FIELD

The present disclosure relates to the field of high-voltage and insulation technologies, and more particularly, to a high-voltage coil formed by casting, a manufacturing method thereof, and a transformer using the high-voltage coil.

### BACKGROUND

In a power system, a transformer is an important member to realize power transmission, and the performances thereof have a great impact on the reliability of the power system and the quality of power energy.

An industrial frequency transformer, especially a thy-type transformer, is widely used in the power systems due to the advantages of fire prevention, moisture protection, high reliability, small size and light weight. A casting process is usually used in the dry-type transformer to encapsulate a winding wire to achieve an insulation function, but partial discharge still may occur in the transformer. The problems appearing in the casting process are illustrated in the examples of insulation design of an epoxy-cast dry-type transformer and a casting-type voltage transformer. For the epoxy-cast dry-type transformer, the glass fiber cloth with epoxy resin coating between different layers is used to fabricated the winding frame which needs to be heat-cured to form a solid insulation. So micro defects such as cracks and voids will be easily formed inside the winding frame during this process, causing partial discharges when applied an voltage, and reducing the insulation strength. For the casting-type voltage transformer, there are two problems. First, interfaces of different materials are formed between two ends of the winding frame and in a resin casted layer, which may work as discharge paths from primary winding to iron core, and reduce the insulation strength. Second, a soft buffer layer wrapping the iron core cannot be completely saturated by epoxy resin during the casting process, forming many voids inside the transformer which increase the risk of partial discharge.

In recent years, a power electronic transformer has been gradually and widely used in the field of power transmission and distribution due to the advantages of small size, light weight, small no-load loss, high power density and high efficiency. The power electronic transformer mainly includes a high-voltage coil, a low-voltage coil, a magnetic core. From the point of view of insulation design, the structure form, material selection and manufacturing method of the high-voltage coil shall be specially concerned. With the size reduction and voltage increase of the power electronic transformer, the electrical stress borne by the insulation structure of the high-voltage coil increases correspondingly, thereby having higher requirements on temperature rise and heat dissipation of the transformer material and structure. Similarly, if the high-voltage coil is made by casting, the problems above in the dry-type transformer may also exist.

In conclusion, the insulation design of the existing transformer at least has the following shortcomings: firstly, it is easy to cause micro defects such as cracks and air holes inside the transformer; secondly, the casting material can not completely saturate the wrapped glass fiber cloth, cable paper, polyester film and other materials, and easily forms the air gap defect; and thirdly, there is an interface between different parts and materials in the insulation layer wrapping the winding. These shortcomings may weaken the insulation performance of the transformer. Therefore, a high-voltage coil that can solve the problems above, and a manufacturing method thereof are needed.

It should be noted that the information disclosed in the above background section is only for enhancement of understanding the background of the present disclosure and therefore can include other information that does not form the prior art that is already known to those of ordinary skills in the art.

### SUMMARY

In order to solve the design problem of the insulation structure of the transformer, improve the shortcoming of partial discharge performance caused by the air gap defect inside the transformer, and increase the electric strength of the whole insulation structure of the transformer, the present disclosure provides a high-voltage coil formed by casting and a manufacturing method thereof, and a transformer using the high-voltage coil.

According to a first aspect of the embodiments of the present disclosure, a method for manufacturing a high-voltage coil is provided, including:

forming a winding frame by casting a first casting material;

forming a winding by coiling a wire around the winding frame;

assembling the winding in a shell; and

casting a second casting material between the winding frame and the shell, enabling the second casting material to be fully filled between the winding frame and the shell.

According to a second aspect of the embodiments of the present disclosure, a high-voltage coil is provided, including:

a shell;

a winding frame formed by casting a first casting material and arranged in the shell;

a winding formed by coiling a wire around the winding frame; and

a filling layer formed by a second casting material casted between the shell and the winding frame.

According to the third aspect of the embodiment of the present disclosure, a transformer is provided, which includes:

the high-voltage coil described above;

a low-voltage coil; and

a magnetic core.

It should be understood that the foregoing general description and the following detailed description are exemplary and explanatory only, and cannot limit the present disclosure.

### BRIEF DESCRIPTION OF THE DRAWINGS

The accompanying drawings herein are incorporated in and constitute a part of this description, illustrate the embodiments in conformity with the invention, and serve to explain the principles of the invention together with the description. Obviously, the drawings in the following description merely relate to some embodiments of the invention, and based on these drawings, those of ordinary skills in the art may obtain other drawings without going through any creative effort.

FIG. 1 is a flow chart of a first embodiment of a method for manufacturing a high-voltage coil in the present disclosure.

FIG. 2A to FIG. 2C are flow charts of a second embodiment to a fourth embodiment of the method for manufacturing a high-voltage coil in the present disclosure in sequence.

FIG. 3A is a stereoscopic structure diagram of the first embodiment of the high-voltage coil in the present disclosure.

FIG. 3B illustrates a cross-section view of the high-voltage coil in FIG. 3A at A1 to A1′.

FIG. 4A illustrates a cross-section view of the second embodiment of the high-voltage coil in the present disclosure.

FIG. 4B is a partial enlarged diagram of the high-voltage coil in FIG. 4A.

FIG. 4C illustrates another structure of a first positioning hole of FIG. 4A.

FIG. 5A illustrates a cross-section view of the third embodiment of the high-voltage coil in the present disclosure.

FIG. 5B is a partial enlarged diagram of the high-voltage coil in FIG. 5A.

FIG. 5C illustrates a perspective view of a cross section of the high-voltage coil in FIG. 5A.

FIG. 5D illustrates another structure of the first positioning hole of FIG. 5A.

FIG. 6A illustrates a cross-section view of the fourth embodiment of the high-voltage coil in the present disclosure.

FIG. 6B illustrates another structure of a winding frame in FIG. 6A.

FIG. 7A illustrates a cross-section view of a fifth embodiment of the high-voltage coil in the present disclosure.

FIG. 7B illustrates another structure of a winding frame in FIG. 7A.

FIG. 8A illustrates a cross-section view of the fifth embodiment of the high-voltage coil in the present disclosure.

FIG. 8B illustrates another structure of a winding frame in FIG. 8A.

FIG. 9A is a structure diagram of a transformer of the present disclosure.

FIG. 9B is another structure diagram of the transformer of the present disclosure.

FIG. 9C is yet another structure diagram of the transformer of the present disclosure.

### DETAILED DESCRIPTION

The example embodiments will be now described more comprehensively with reference to the drawings. However, the example embodiments can be embodied in many forms and should not be construed as being limited to the embodiments set forth herein; on contrary, these embodiments are provided so that the invention will be more comprehensive and complete, and the concept of the example embodiments will be comprehensively conveyed to those skilled in the art. Furthermore, the described features, structures, or characteristics may be combined in any suitable manner in one or more embodiments. In the following description, numerous specific details are set forth, so as to give sufficient understanding on the embodiments of the invention. However, those skilled in the art will appreciate that the technical solution of the invention may be practiced while omitting one or more of the specific details, or other methods, constituent elements, materials, devices, steps, etc. In other instances_{;} various aspects of the present disclosure are not obscured by the detailed illustration or description of the known technical solutions to avoid distracting.

In addition, the drawings are only schematic illustrations of the present invention, and the same reference numerals in the drawings indicate the same or similar parts, so repeated descriptions thereof will be omitted.

The embodiments of the present invention will be described in detail hereinafter with reference to the accompanying drawings.

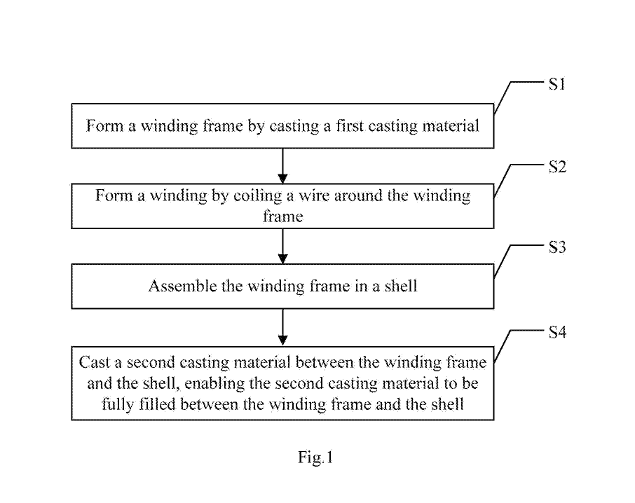

FIG. 1 is a flow chart of a first embodiment of a method for manufacturing a high-voltage coil in the present disclosure. With reference to FIG. 1, the method for manufacturing a high-voltage coil includes:

step S1: forming a winding frame by casting a first casting material;

step S2: forming a winding by coiling a wire around the winding frame;

step S3: assembling the winding frame in a shell and

step S4: casting a second casting material between the winding frame and the shell, enabling the second casting material to be fully filled between the winding frame and the shell.

The winding frame is casted by the first casting material, and the process and equipment adopted can eliminate residual bubbles in the winding frame, thereby reducing internal defects. Meanwhile, since the second casting material is completely filled bet the winding frame and the shell through casting again, a solid insulation structure between high and low voltages (between the winding and the shell) is formed, thereby further improving an insulation strength of the high-voltage coil.

In step S1, a mould for casting the winding frame can be sent to a vacuum casting or automatic pressure gel equipment, followed by the casting steps of drying, vacuum casting, curing, demolding, polishing and shaping, so as to finally make the winding frame.

In step S2, the winding frame can have a groove for containing the winding, so as to facilitate fixing the winding. For example, the wire can be a varnished wire winded in the groove. The groove can be made in the step of polishing and shaping in step S1, or can also be directly made in the step of vacuum casting in step S1, and the present disclosure is not limited thereto. Preferably, a depth of the groove can be set to be no less than a thickness of the winding, then bosses (covex plates) at two sides of the groove can form a barrier, and an internal discharge route of the high-voltage coil is changed to further reduce a probability of partial discharge of the high-voltage coil. In some other embodiments, for the purpose of simplifying the manufacturing process, the groove of the winding frame may also be omitted.

In step S3, the shell can be made of a conductive material, and is grounded, so that a surface potential of the shell is a zero potential, thereby guaranteeing the security of the user. In some embodiments, the shell can further have an outlet hole to contain an outlet end of the winding in step S2, and the winding is electrically connected to an external circuit through the outlet end.

In step S4, a workpiece finished in step S3 can be sent to the vacuum casting equipment, followed by drying, vacuum casting, curing, demolding, polishing and shaping, so as to finally make the high-voltage coil. In some embodiments, the second casting material with the coefficient of thermal expansion similar to that of the first casting material can be selected to reduce the internal stress of the filling layer formed by the second casting material, increase a mechanical strength of the filling layer, and prevent crack of the filling layer. Preferably, a difference between coefficients of thermal expansion of the first casting material and the second casting material can be limited to be no greater than 20%, or the first casting material and the second casting material are set to be the same material. For example, the first casting material and the second casting material can be resin material such as epoxy resin, polyurethane or benzoxazine.

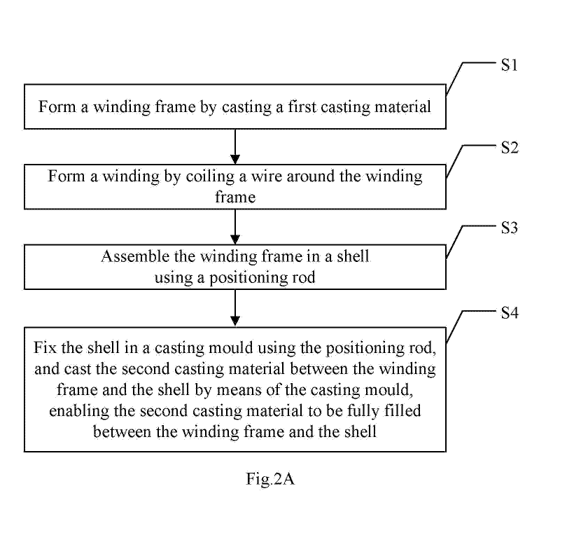

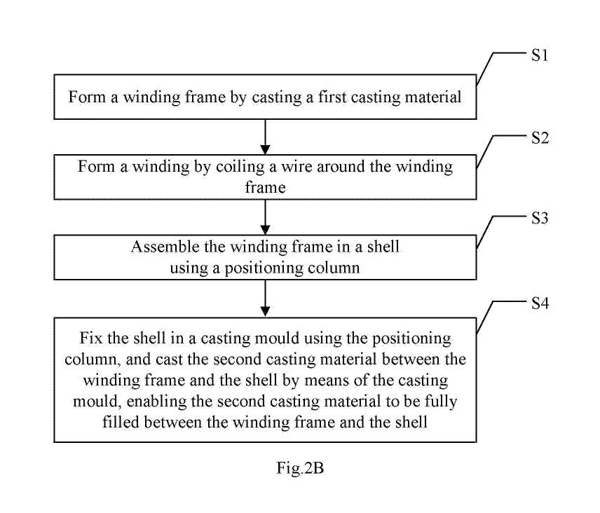

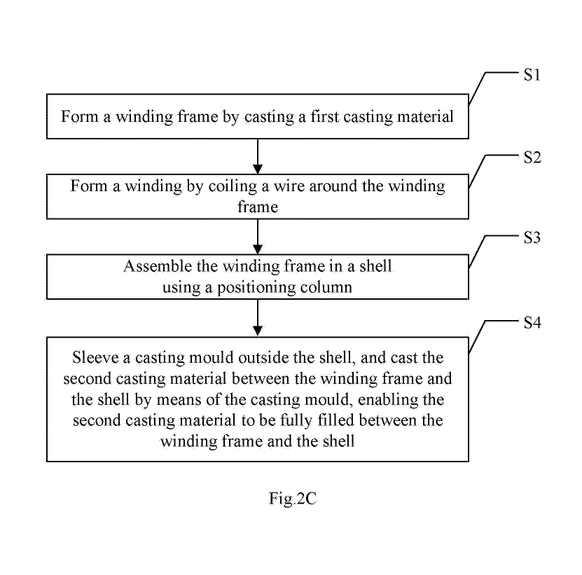

FIG. 2A is a flow chart of a second embodiment of the method for manufacturing a high-voltage coil in the present disclosure. In an exemplary embodiment of the present disclosure, the shell has a first positioning hole, and the winding frame has a second positioning hole. With reference to FIG. 2A, in an embodiment, the implementation manner of step S3 may be as follows: assembling the winding frame in the shell by means of a positioning rod, wherein two ends of the positioning rod are respectively clamped in the first positioning hole and the second positioning hole; and the implementation manner of step S4 may be as follows: fixing the shell in a casting mould by means of the positioning rod, and casting the second casting material between the winding frame and the shell by means of the casting mould, so that the second casting material is completely filled between the winding frame and the shell. The first positioning hole is a through hole, the positioning rod has an extending portion protruding out of the first positioning hole, the casting mould has a third positioning hole, and the extending portion of the positioning rod is clamped in the third positioning hole. The positioning rod can be made of a metal material, and can also be made of an insulation material. When the positioning rod is made of the metal material, the positioning rod needs to be removed after finishing step S4 to meet the requirement on insulation.

FIG. 2B is a flow chart of a third embodiment of the method for manufacturing a high-voltage coil in the present disclosure. In an exemplary embodiment of the present disclosure, the shell has a first positioning hole, and the winding frame has a positioning column protruding out of a surface. With reference to FIG. 2B, in another embodiment, the implementation manner of step S3 may be as follows: assembling the winding frame in the shell by means of the positioning column, wherein the positioning column is clamped in the first positioning hole; and the implementation manner of step S4 may be as follows: fixing the shell in a casting mould by the positioning column, and casting the second casting material between the winding of the winding frame and the shell by means of the casting mould, so that the second casting material is completely filled between the winding frame and the shell. The first positioning hole is a through hole, the casting mould has a third positioning hole, the positioning column has an extending portion protruding out of the first positioning hole, and the extending portion is clamped in the third positioning hole.

In the embodiments above, when the positioning rod is made of the metal material, the winding frame can be exposed to the air since the positioning rod needs to be removed; and when the positioning rod is made of the insulation material, although the positioning rod does not need to be removed, when the positioning rod is clamped in the first positioning hole, the material thereof is often inconsistent with the material of the shell. Therefore, a size of the first positioning hole needs to be reasonably set according to a security requirement of the surface potential of the shell of the high-voltage coil. Similarly, the size of the first positioning hole also needs to be considered when the shell and the winding mould are fixed by the positioning column. Preferably, a proportion of the first positioning hole to a surface area of the shell can be set to be no greater than 2%.

In the embodiment above, and in step S4 above, a depth of the third positioning hole can further be set to be no greater than 10 mm to facilitate the assembly.

FIG. 2C is a flow chart of a third embodiment of the method for manufacturing a high-voltage coil in the present disclosure.

With reference to FIG. 2C, and compared with the second embodiment, the implementation manner of step S4 in the embodiment may be as follows:

directly sleeving the casting mould outside the shell, and casting the second casting material between the winding of the winding frame and the shell by means of the casting mould, so that the second casting material is completely filled between the winding frame and the shell. Since the positioning rod or the positioning column does not need to be connected to the casting mould, the first positioning hole can be made into a non-through hole, and the security guarantee is higher than that of the embodiment above in which the first positioning hole is the through hole.

In some other embodiments of the present disclosure, the second casting material can also be casted through other methods without the help of the casting mould, which is not limited by the present disclosure.

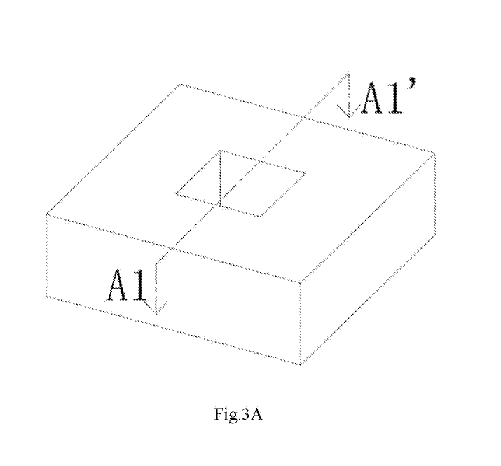

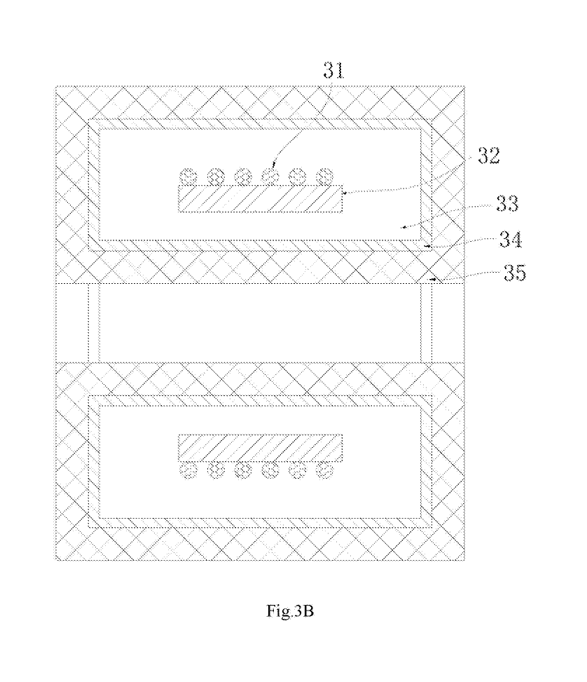

FIG. 3A is a stereoscopic structure diagram of the first embodiment of the high-voltage coil in the present disclosure. However, the present disclosure is not limited thereto, and the high-voltage coil can have other shapes.

FIG. 3B illustrates a cross-section view of the high-voltage coil in FIG. 3A at A1 to A1′ and a casting mould fitted. The high-voltage coil shown in FIG. 3A to FIG. 33 can be made by the manufacturing method as shown in FIG. 1.

With reference to FIG. 3B, a high-voltage coil 3 includes a winding 31, a winding frame 32, a filing layer 33 and a shell 34. The winding frame 32 is casted by the first casting material, the wire is winded on the winding frame 32 to form the winding 31, the winding frame 32 is arranged in the shell 34, and the filing layer 33 is formed by the second casting material casted between the shell 34 and the winding frame 32. In the embodiment, the filling layer 33 is casted by means of a casting mould 35, and after finishing casting, the casting mould 35 is removed. In some other embodiments of the present invention, the casting mould can also be omitted during a manufacturing process, and the present disclosure does not limit specific casting method of the filling layer.

The winding frame 32 is casted by the first casting material, and the process and equipment adopted can eliminate residual bubbles in the winding frame, thereby reducing the internal detect. Meanwhile, since the second casting material is completely filled between the winding frame 32 and the shell 34 through casting again, the filling layer 33 is formed, so that a solid insulation structure between high and low voltages (between the winding 31 and the shell 34) is formed, thereby further improving an insulation strength of the high-voltage coil.

In sonic embodiments, the second casting material with the coefficient of thermal expansion similar to that of the first casting material can be selected to reduce the internal stress of the filling layer 33, increase a mechanical strength of the filling layer 33, and prevent crack of the filling layer 33. Preferably, a difference between coefficients of thermal expansion of the first casting material and the second casting material can be limited to be no greater than 20%, or the first casting material and the second casting material are set to be the same material. For example, the first casting material and the second casting material can belong to resin materials such as epoxy resin, polyurethane or benzoxazine.

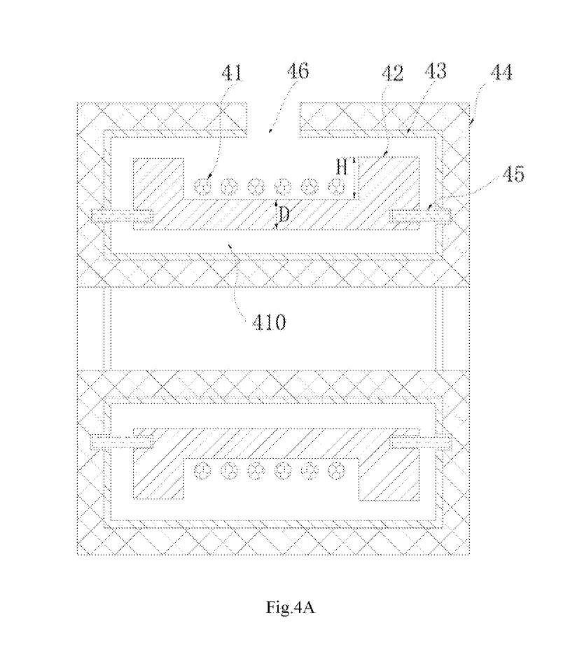

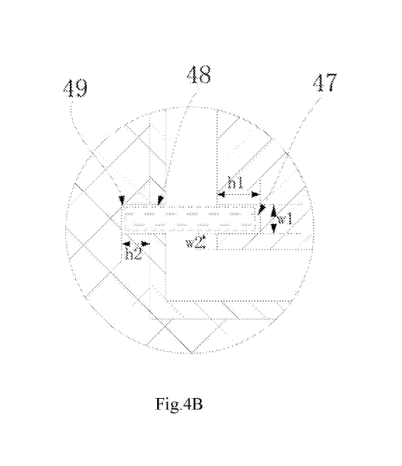

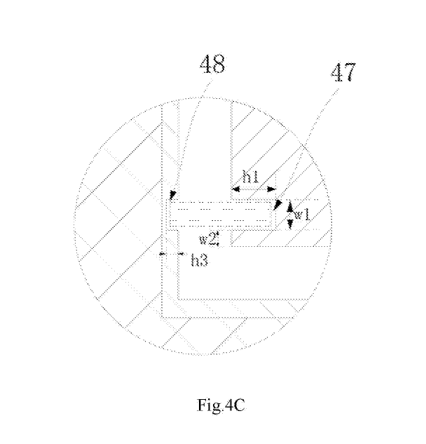

FIG. 1A illustrates a cross-section view of the second embodiment of the high-voltage coil in the present disclosure. The high-voltage coil shown in FIG. 4A can be made by the method for manufacturing a high-voltage coil shown in FIG. 2A.

With reference to FIG. 4A, a winding frame 42 is casted by the first casting material, with the groove for containing the wire, the wire is winded in the groove of the winding frame 42 to form a single-layer winding 41, and preferably, an insert depth H is no less than a diameter of the wire, bosses (convex plates) at two sides of the groove can form a barrier, and an internal discharge route of the high-voltage coil is changed to further reduce a. probability of partial discharge of the high-voltage coil. In some other embodiments of the present disclosure, the wire is winded on the winding frame 42, which can also form multiple-layer winding, and similarly, the insert depth H of the groove can be set to be no less than a thickness of the winding. In sonic other embodiments of the present disclosure, as shown in FIG. 4A, a shell 43 can further have an outlet hole 46, which can contain an outlet end of the single-layer or multiple-layer winding. It shall be noted that the present disclosure does not limit a size and a position of the outlet hole 46 of the shell 43.

FIG. 4B is a partial enlarged diagram of the high-voltage coil in FIG. 4A, and with reference to FIG. 4A and FIG. 4B, the shell 43 has a first positioning hole 48, and the winding frame 42 has a second positioning hole 47. The winding frame 42 can be fixed in the shell 43 through a positioning rod, two ends of a positioning rod 45 are respectively clamped in the first positioning hole 48 and the second positioning hole 47. A position and a number of the positioning rod 45 can be set by those skilled in the art, as long as the solution with the purpose of fixing the winding frame 42 is included in the protection scope of the present disclosure. In the embodiment, a shortest distance from a side wall of the second positioning hole 47 to an inner side of the winding frame 42 is less than a shortest distance from an outer side to the inner side of the winding frame, that is w2<D. In an exemplary embodiment of the present disclosure, the positioning rod can be located at any two sides of the winding frame 42, i.e., two sides that are not coplanar, so that the fixation is better. In another exemplary embodiment of the present disclosure, an electric field strength in the second positioning hole 47 is ensured to be lower than a breakdown field strength of air through setting the size of the second positioning hole 47, so as to further improve the insulation performance of the high-voltage coil. For example, an aperture w1 of the second positioning hole 47 can be set as being no greater than 5 mm, and a hole depth h1 can be set as being no greater than 5 mm.

With reference to FIG. 4B again, the first positioning hole 48 is a through hole, a casting mould 44 can have a third positioning hole 49, the positioning rod 45 has an extending portion, and the extending portion is clamped in the third positioning hole 49. In an exemplary embodiment of the present disclosure, a depth h2 of the third positioning hole 49 is no greater than 10 mm, with simple structure, thereby facilitating production assembly. It needs to be stated that the positioning rod 45 can be made of a metal material, and can also be made of an insulation material. When the positioning rod is made of the metal material, the positioning rod needs to be removed to meet the insulation requirement after the high-voltage coil is made; when the positioning rod is made of the insulation material, the positioning rod can still be remained in the high-voltage coil after the high-voltage coil is made, and the portion of the positioning rod protruding out of the shell is worn to make the surface of the high-voltage coil smooth. In an exemplary embodiment of the present disclosure, a size of the first positioning hole 48 can be set according to a security requirement of the surface potential of the shell of the high-voltage coil to further improve the insulation performance. For example, a proportion of the first positioning hole to a surface area of the shell is set to be no greater than 2%.

In some other embodiments of the present disclosure, the first positioning hole can also be a non-through hole. FIG. 4C illustrates another structure of the first positioning hole of FIG. 4A. With reference to FIG. 4C, when the first positioning hole 18 is the non-through hole, a hole depth h3 of the first positioning hole 48 is less than a thickness of the shell 43, the casting mould is directly sleeved outside the shell, and compared with the embodiment in which the first positioning hole is the through hole, when the first positioning hole 48 is set to be the non-through hole, the safety guarantee is higher.

In the embodiment shown in FIG. 4A to FIG. 4C, a tilling layer 410 is formed through casting between the shell 43 and the winding frame 42 by means of the casting mould 44, and the casting mould needs to be removed after finishing casting.

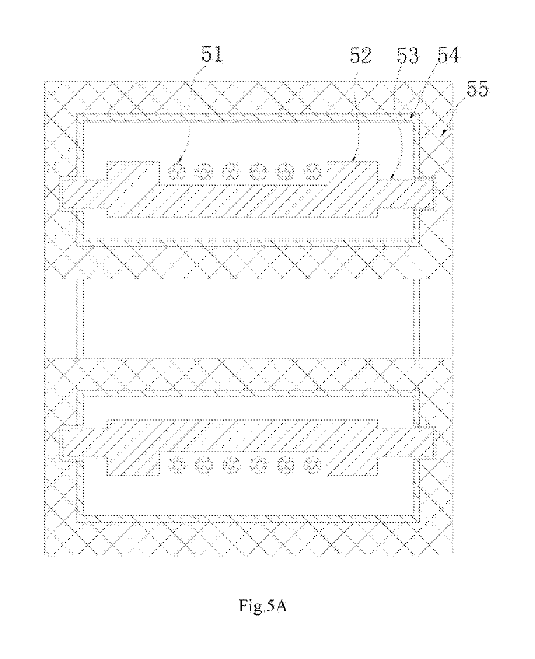

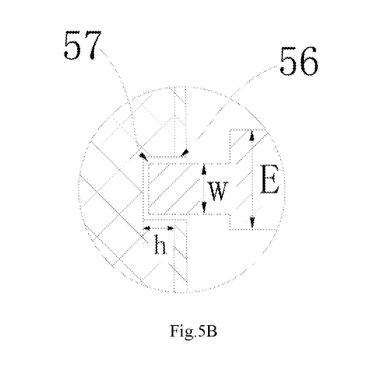

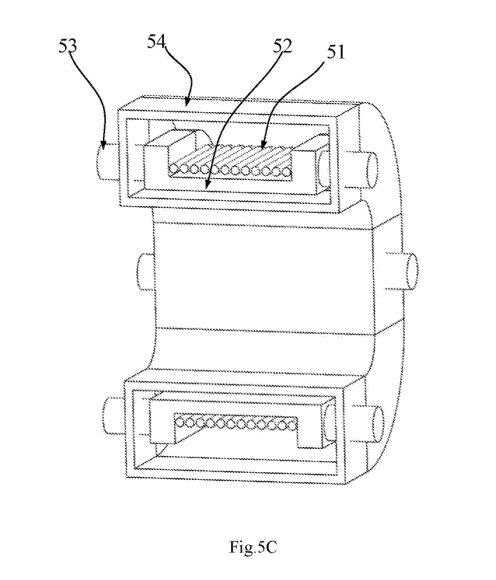

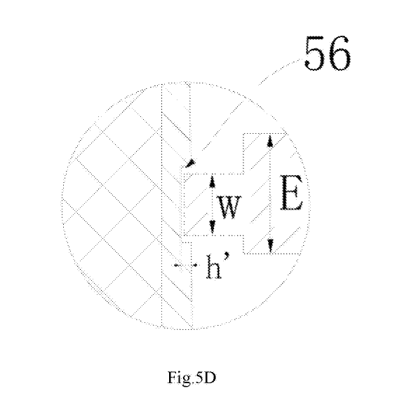

FIG. 5A illustrates a cross-section view of the third embodiment of the high-voltage coil in the present disclosure. FIG. 5B is a partial enlarged diagram of the high-voltage coil in FIG. 5A. FIG. 5C illustrates a perspective view of a cross section of the high-voltage coil in FIG. 5A. The high-voltage coil shown in FIG. 5A can be made by the method for manufacturing a high-voltage coil shown in FIG. 2B. With reference to FIG. 5A to FIG. 5C, the wire is winded on a winding frame 52 to form a winding 51, the winding frame 52 has a positioning column 53 protruding out of two end surfaces, and a width W of the positioning column is no greater than a height F of the boss of the winding frame 52. The winding frame 52 is fixed in a shell 54 through the positioning column 53, wherein the positioning column 53 is clamped in a first positioning hole 56 of the shell 54. The positioning column shown in FIG. 5A to FIG. 5C is a cylinder, which does not limit the present disclosure.

With reference to FIG. 5B continuously, the first positioning hole 56 is a through hole, the positioning column 53 has an extending portion protruding out of the shell 54, a casting mould SS has a third positioning hole 57, and the extending portion of the positioning column 53 is clamped in the third positioning hole 57. In an exemplary embodiment of the present disclosure, a depth h of the third positioning hole 57 is no greater than 10 mm, with simple structure, thereby facilitating production assembly. In an exemplary embodiment of the present disclosure, a size of the first positioning hole 48 can be set according to a security requirement of the surface potential of the shell of the high-voltage coil to further improve the insulation performance. For example, a proportion of the first positioning hole to a surface area of the shell is set to be no greater than 2%.

FIG. 5D illustrates another structure of the first positioning hole of FIG. 5A. In the embodiment shown in FIG. 5D, the first positioning hole 56 is a non-through hole, a hole depth h′ of the first positioning hole 56 is less than a thickness of the shell 54, and the casting mould 55 is directly sleeved outside the shell 54, so that the security guarantee is higher.

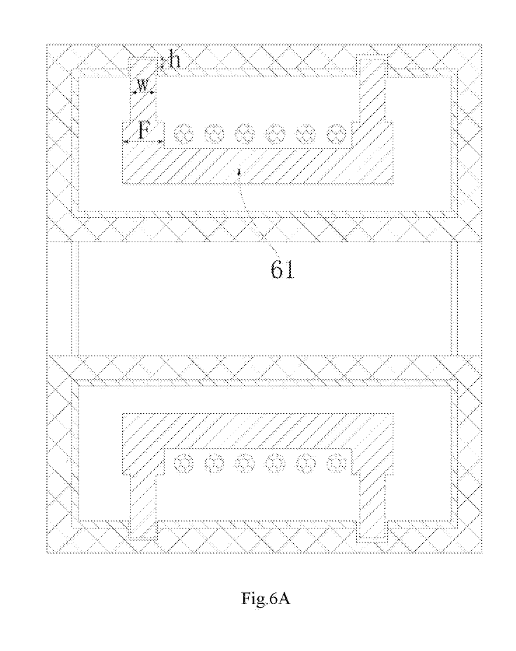

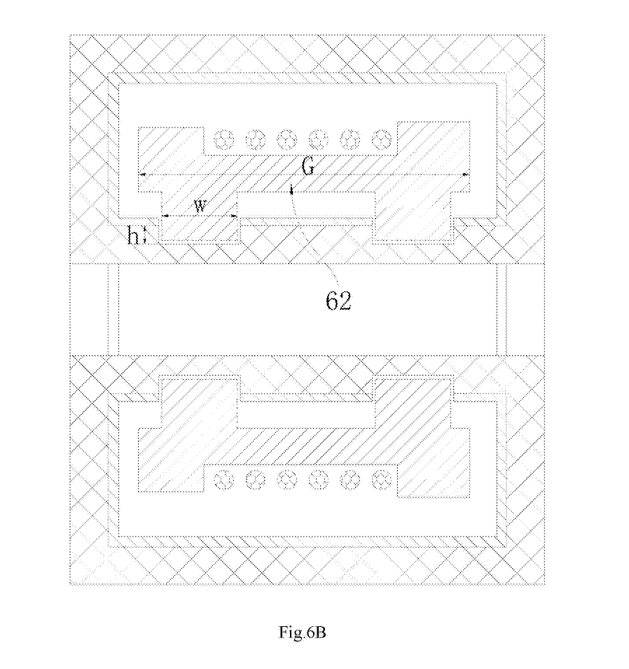

FIG. 6 to FIG. 8 illustrate a structure of a winding frame in some other embodiments of the present disclosure, and the portion similar to the embodiment above is not repeated hereinafter.

FIG. 6A illustrates a cross-section view of the fourth embodiment of the high-voltage coil in the present disclosure. In FIG. 6A, the positioning column of a winding frame 61 protrudes towards an outer side of the winding frame, and is inserted in the shell and the positioning hole of the casting mould. The positioning column can be located on bosses (convex plates) at two sides of the groove of the winding frame 61, a width W of the positioning column is no greater than a width F of the boss of the winding frame 61, and that is W≤F.

FIG. 6B illustrates another structure of the winding frame in FIG. 6A. In FIG. 6B, the positioning column of a winding frame 62 protrudes towards an inner side of the winding frame, and is inserted in the shell and the positioning hole of the casting mould, a number n of the positioning columns is no less than 1, and a sum of widths of a plurality of positioning columns is no greater than a total width G of the winding frame 62, that is n*W≤G.

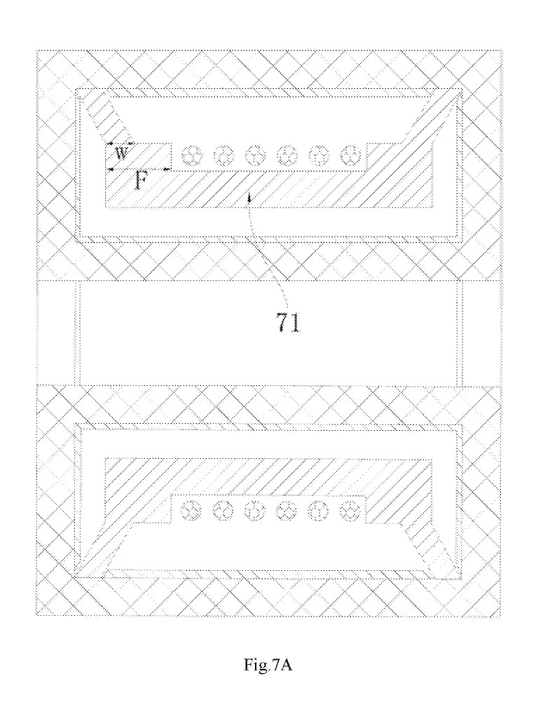

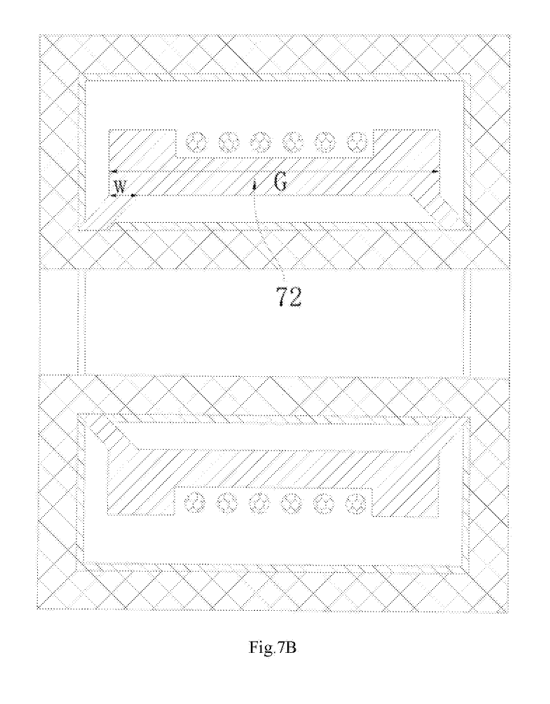

FIG. 7A illustrates a cross-section view of the fourth embodiment of the high-voltage coil in the present disclosure.

In FIG. 7A, a winding frame 71 is fixed at a corner of the mould through a positioning column protruding out of a corner position outside the winding frame, and is clamped in the first positioning hole of the shell, a width W of the positioning columns no greater than F, and F is a width of the boss of the winding frame 71.

FIG. 7B illustrates another structure of the winding frame in FIG. 7A. In FIG. 7B, a winding frame 72 is fixed at a corner of the mould through a positioning column protruding out of a corner position inside the winding frame, and is clamped in the first positioning hole of the shell, a width W of the positioning column is no greater than G/2, and G is a width of the winding frame 71.

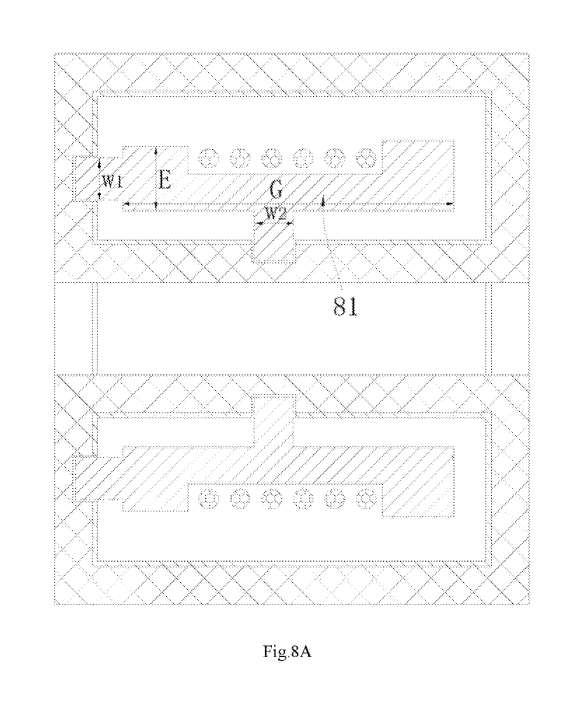

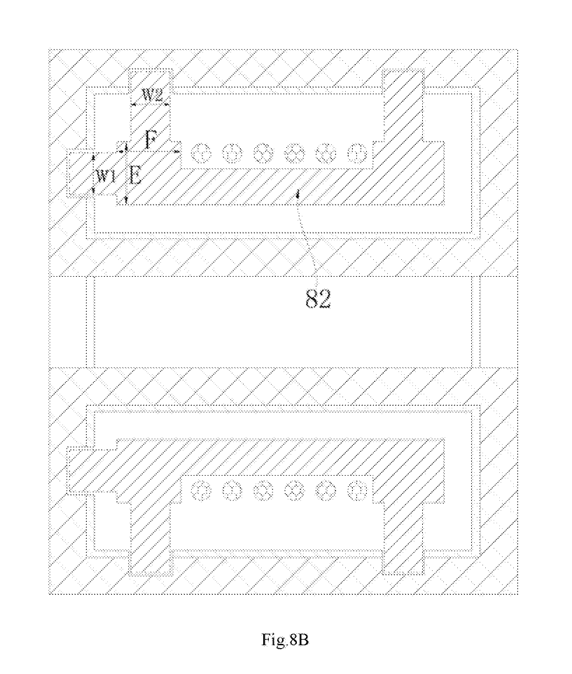

FIG. 8A illustrates a cross-section view of a fifth embodiment of the high-voltage coil in the present disclosure.

In FIG. 8A, a winding frame 81 is fixed in the shell and the casting mould through a positioning column protruding out of an end inside the winding frame, wherein a width W1 of the positioning column at the end portion is no greater than E, E is a height of the boss of the winding frame 81, a width W2 of the positioning column at the inner side is no greater than G and G is a width of the winding frame 81.

FIG. 8B illustrates another structure of the winding frame in FIG. 8A. In FIG. 8B, a winding frame 82 is fixed in the shell and the casting mould through the positioning column protruding out of an end and an outer side of the winding frame, wherein a width W1 of the positioning column at the end portion is no greater than E, E is a height of the boss of the winding frame 81, a width W2 of the positioning column at the outer side is no greater than F, and F is a width of the boss of the winding frame 81.

In the present disclosure, the number and the position of the positioning column or the positioning rod can also be varied, and those skilled in the art can set the positioning column and the positioning rod according to the actual situation, which is not particularly limited in the present disclosure. A structure capable of fixing the winding frame is included in the protection scope of the present invention.

In the present disclosure, FIG. 39 to FIG. 59, and FIG. 5D to FIG. 8B illustrate that the casting mould can be removed after finishing casting.

The present disclosure further provides a transformer using the high-voltage coil.

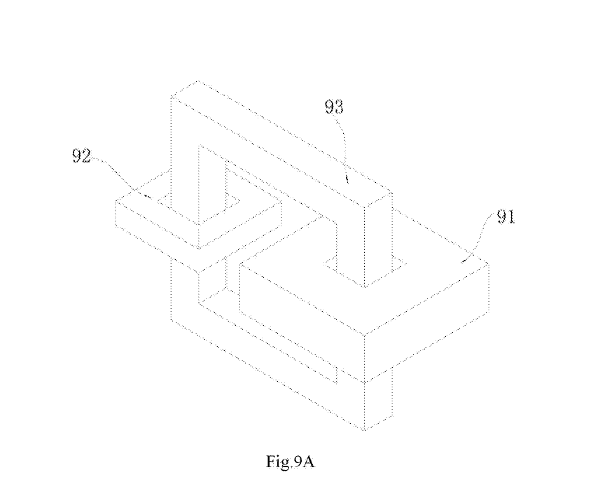

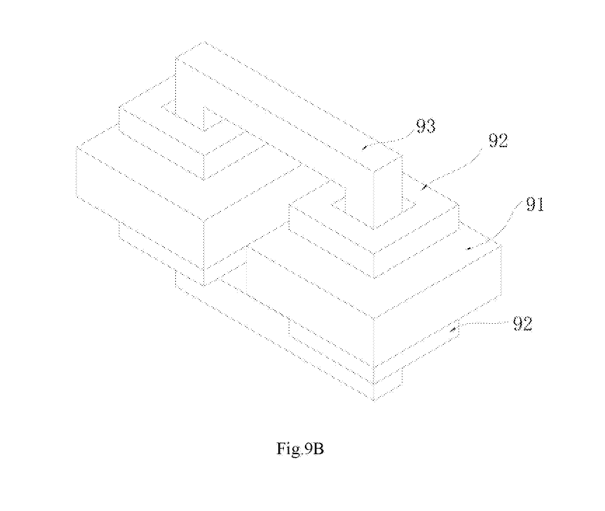

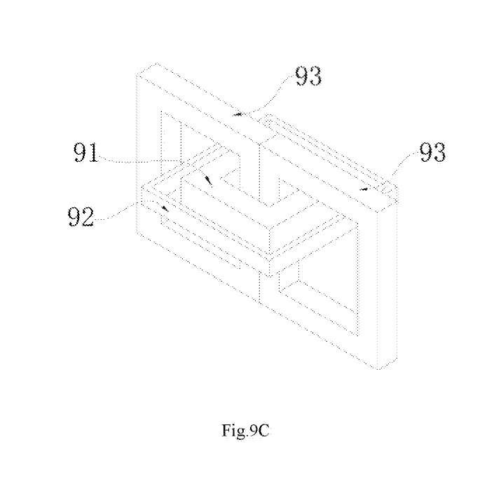

With reference to FIG. 9A to FIG. 9C, a high-voltage coil 91, a low-voltage coil 92 and a magnetic core 93 are assembled in difference combination forms to obtain a finished product of the transformer, which does not limit the present invention.

In FIG. 9A, the high-voltage coil 91 and the low-voltage coil 92 are respectively sleeved on two core columns of the magnetic core 93. In FIG. 9B, the high-voltage coil 91 is overlapped between two low-voltage coils 92, which are arranged on the same core column jointly. In FIG. 9C, the low-voltage coil 92 is sleeved outside the high-voltage coil 91, which are arranged on the same core column jointly.

In conclusion, the solution provided by the present disclosure has partial or whole advantages as follows.

Firstly, the winding frame is casted, thereby avoiding the air gap defect inside the high-voltage coil, and improving the partial discharge performance;

secondly, the second casting material is fully filled between the winding frame and the shell, thereby isolating the communication surface between high and low voltage potentials, and increasing the insulation strength of the high-voltage coil; and

thirdly, the first casting material and the second casting material with similar coefficients of thermal expansion are selected, thereby reducing the internal stress and preventing crack.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. The description and embodiments are to be regarded as illustrative only, and the real scope and conceive of the invention are pointed out in the claims.

What is claimed is:

1. A method for manufacturing a high-voltage coil, comprising:
forming a winding frame by casting a first casting material;
forming a winding by coiling a wire around the winding frame;
assembling the winding frame in a shell; and
casting a second casting material between the winding frame and the shell, enabling the second casting material to be fully filled between the winding frame and the shell.

2. The method for manufacturing a high-voltage coil of claim 1, wherein the first casting material and the second casting material are same.

3. The method for manufacturing a high-voltage coil of claim 1, wherein a difference between coefficients of thermal expansion of the first casting material and the second casting material is no greater than 20%.

4. The method for manufacturing a high-voltage coil of claim 1, wherein the winding frame is provided with a groove for containing the winding, and a depth of the groove is no less than a thickness of the winding.

5. The method for manufacturing a high-voltage coil of claim 1, wherein the shell is provided with an outlet hole, and an outlet end of the winding is positioned in the outlet hole.

6. The method for manufacturing a high-voltage coil of claim 1, the assembling the winding frame in the shell comprises one of following steps:
assembling the winding frame in the shell using a positioning rod, wherein two ends of the positioning rod are respectively engaged within a first positioning hole of the shell and a second positioning hole of the winding frame; and
assembling the winding in the shell using a positioning column of the winding frame, the positioning column protruding out of a surface of the winding frame and being engaged within the first positioning hole of the shell.

7. The method for manufacturing a high-voltage coil according to claim 6, wherein the casting a second casting material between the winding frame and the shell comprises:
fixing the shell in a casting mould using one of the positioning rod and the positioning column, and casting between the winding frame and the shell by means of the casting mould;
wherein the first positioning hole is a through hole, the casting mould is provided with a third positioning hole, the one of the positioning rod and the positioning column is provided with an extending portion protruding out of the first positioning hole, and the extending portion is engaged within the third positioning hole.

8. The method for manufacturing a high-voltage coil according to claim 6, wherein the first positioning hole is a non-through hole, and the casting a second casting material between the winding frame and the shell comprises:
sleeving a casting mould outside the shell, and casting between the winding frame and the shell by means of the casting mould.

9. The method for manufacturing a high-voltage coil according to claim 7, wherein a proportion of the first positioning hole to a surface area of the shell is no greater than 2%.

10. A high-voltage coil, comprising:
a shell;
a winding frame arranged in the shell and formed by casting a first casting material;
a winding formed by coiling a wire around the winding frame; and
a filling layer formed by a second casting material casted between the shell and the winding frame.

11. The high-voltage coil of claim 10, wherein the first casting material and the second casting material are same.

12. The high-voltage coil of claim 10, wherein a difference between coefficients of thermal expansion of the first casting material and the second casting material is no greater than 20%,

13. The high-voltage coil of claim 10, wherein the winding frame is provided with a groove for containing the winding, and a depth of the groove is no less than a thickness of the winding.

14. The high-voltage coil of claim 10, wherein the shell is provided with an outlet hole, and an outlet end of the winding is positioned in the outlet hole.

15. The high-voltage coil of claim 10, wherein the shell is provided with a first positioning hole, the winding frame is provided with a second positioning hole, the winding frame is fixed in the shell using a positioning rod, and two ends of the positioning rod are respectively engaged within the first positioning hole and the second positioning hole.

16. The high-voltage coil of claim 10, wherein the winding frame is provided with a positioning column protruding out of a surface.

17. The high-voltage coil of claim 16, wherein the shell is provided with a first positioning hole, the winding frame is fixed in the shell using the positioning column, and the positioning column is engaged within the first positioning hole.

18. The high-voltage coil of claim 16, wherein the positioning column is located at any two sides of the surface of the winding frame,

19. The high-voltage coil of claim 16, wherein the winding frame is provided with a groove for containing the winding, the positioning column is located on bosses at two sides of the groove, and a width of the positioning column is no greater than a width of the boss.

20. A transformer, comprising:
a high-voltage coil;
a low-voltage coil; and
a magnetic core,
wherein the high-voltage coil comprises:
a shell;
a winding frame arranged in the shell and formed by casting a first casting material;
a winding formed by coiling a wire around the winding frame; and
a filling layer formed by a second casting material casted between the shell and the winding frame.
